(19) United States
(12) Patent Application Publication
(10) Pub. No.: US 2011/0119330 A1
(43) Pub. Date: May 19, 2011

(54) SELECTIVE CONTENT LOADING BASED ON COMPLEXITY

(75) Inventors: James A. Baldwin, Palto Alto, CA (US); Nicolae Surpatanu, San Jose, CA (US); Bradley Robert Pettit, Los Gatos, CA (US); Prashant Singh, San Francisco, CA (US); Junmin Hao, Cupertino, CA (US); Patrick Schuler, Bülach (CH)

(73) Assignee: MICROSOFT CORPORATION, Redmond, WA (US)

(21) Appl. No.: 12/710,249

(22) Filed: Feb. 22, 2010

Related U.S. Application Data
(60) Provisional application No. 61/261,201, filed on Nov. 13, 2009.

(51) Int. Cl. G06F 3/048; G06F 15/16

(52) U.S. Cl. 709/203; 715/760; 707/791

(57) ABSTRACT

Selective content loading based on complexity is provided by a method of selectively loading content which includes receiving markup data at a client computing device and determining a markup weight for the markup data at the client computing device. The method further includes determining if the markup weight is less than a threshold value at the client computing device. The method further includes, if the markup weight is less than the threshold value, loading the markup data at the client computing device, and if the markup weight is not less than the threshold value, not allowing the markup data to load at the client computing device.

### CROSS REFERENCE TO RELATED APPLICATIONS

This application claims the benefit of U.S. Provisional Patent Application No. 61/261,201, filed Nov. 13, 2009, the entirety of which is hereby incorporated by reference for all purposes.

### BACKGROUND

Computing systems may receive data from various sources such as mass storage devices, removable media, and network-accessible servers, and process the data into objects on the computing system. As an example, a computing system may obtain data which upon rendering yields a user interface having controls executable by the computing system.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

According to one aspect of this disclosure, selective content loading based on complexity may be provided by a method of selectively loading content which includes receiving markup data at a client computing device and determining a markup weight for the markup data at the client computing device. The method further includes determining if the markup weight is less than a threshold value at the client computing device. The method further includes, if the markup weight is less than the threshold value, loading the markup data at the client computing device, and if the markup weight is not less than the threshold value, not allowing the markup data to load at the client computing device.

### BRIEF DESCRIPTION OF THE DRAWINGS

FIG. 1 shows a block diagram of an example computing environment in accordance with an embodiment of the present disclosure.

FIG. 2 shows an example method of selectively loading markup based on an estimated complexity of the markup.

FIG. 3 shows a table of example components of markup and corresponding weights associated with the components.

FIG. 4 shows a computing environment architecture diagram in accordance with an embodiment of the present disclosure.

FIG. 5 shows a block diagram of an example computing system in accordance with an embodiment of the present disclosure.

### DETAILED DESCRIPTION

Computing systems may be configured to render markup data by processing the markup into objects on the computing system. However, rendering sufficiently complex markup may impact system performance and stability, and in some cases may crash the client computing system. Thus, selective content loading based on complexity as disclosed herein allows the client computing device to assign weights to portions of the markup based on how much each portion is estimated to impact the device. Based on such estimates, the client computing device can then allow or deny rendering of the markup.

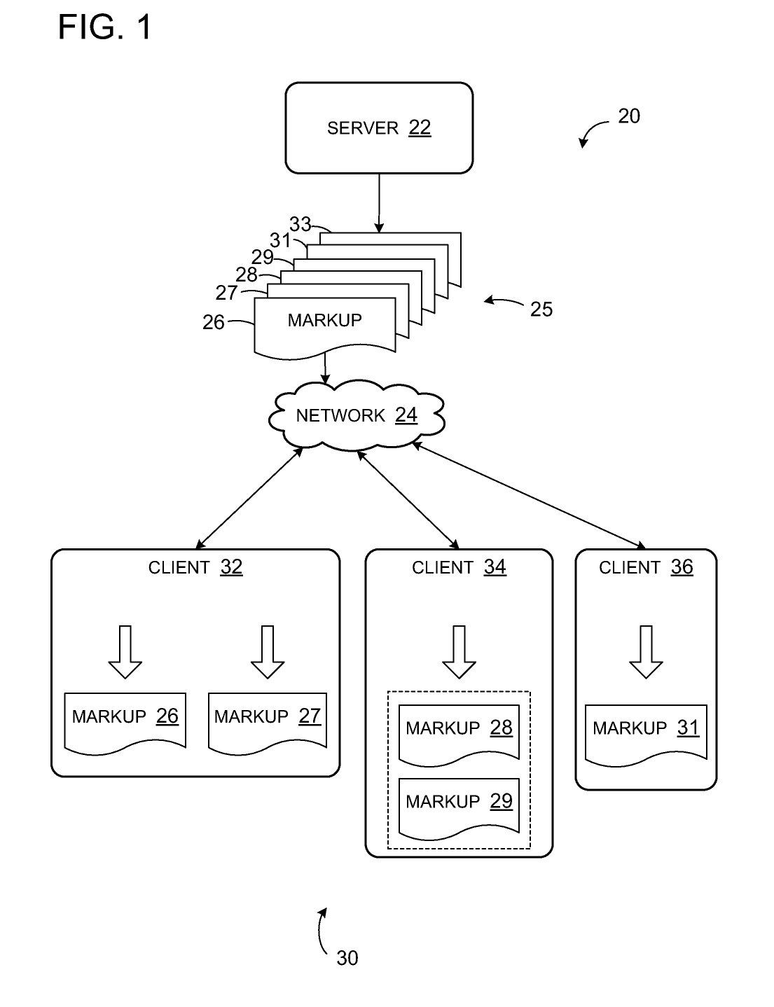

FIG. 1 schematically shows an embodiment of an example computing environment 20 including a network-accessible server 22 configured to send markup data to a plurality of client computing devices 30 via network 24. As used herein, markup data is not limited to a particular markup language such as XML, but rather includes any functional text and/or code block that may be independently loaded on a page by page or component by component basis, as described below. As such, markup data may include XML, scripts, widgets, gadgets, applets, plugins, and the like. As used herein, the term markup is used to refer to raw data transferred to a device as well as the parsed representation or protogadgets derived from the raw data.

Server 22 may include an application server having a web application framework for building web sites/applications/services, and may be configured to serve markup consumable by a client computing device. Upon being consumed at the client computing device, the markup may be rendered into objects such as user interface elements, logical operators, applications, widgets, gadgets, etc. As nonlimiting examples, objects in the form of user interface elements may include buttons, menus, list boxes, text boxes, image boxes, images, animations, and the like.

As an example, FIG. 1 depicts server 22 sending via network 24 example markup data 25 to one or more client computing devices 30. Such client computing devices 30 may include any suitable computing device configured to receive data from a source and render the data for display on a display device. As an example, client computing devices 30 may include a set-top box configured to receive a signal from an external source, and render this signal into content for display on a display device such as a computer display, television screen, or mobile device display.

In some embodiments, one or more client computing devices 30 may have internet protocol (IP) client software which provides an extensibility platform such that third-party developers may write “applications” for the client device. Such applications may have markup located and/or hosted remotely to where the client-computing device is located, such as posted on a web server such as server 22. Upon receiving the markup, a client computing device may then parse the markup into an intermediate, static form such as an intermediate data structure. Such an intermediate data structure contains code for components of the application, that when rendered create objects at the client computing device. As a nonlimiting example, such objects may be user controls for a user interface. Further, such components may be grouped into one or more collections called “pages.” As such, an application may then be described as a logical grouping of one or more pages. In some cases, a developer may specify an application identification on each page so that the client computing device knows which pages are part of an application. A developer may also specify more advanced navigation behavior based on the fact that a set of pages belongs to a single application. Further, the pages of an application may also share some data and markup, so that each page may not have to download the same data repeatedly. In some embodiments, applications may share a base URL and/or a same look and feel, and thus provide pieces of one larger user experience.

As an example of an application, a video on-demand storefront may include a main page that allows the user to browse through movies. Such an application may include another page providing detailed information on a selected movie, another page providing the video playback experience for that movie, etc. As another example of an application, a game may include a character configuration page, another page providing the game play experience, and another page showing wins and losses.

Pages may be further organized using “layers.” A layer is a type of object on the client computing device. In some embodiments, a layer may contain one active page and zero or more inactive pages. Such an inactive page may be, for example, a page that was previously active and is now subsequently held in a history stack. One or more pages may be associated with a main layer providing a majority of an application, such as a user interface. An application may optionally have one or more layers above or below the main layer which have other logic and/or controls on them, such as a floating image, an invisible mini application that observes user input, etc.

Each of client computing devices 30 may be configured to selectively load content by assessing the complexity of received markup before loading the markup. Traditionally upon receiving markup, a client computing device loads the markup, which may result in stressing the client computing device and causing poor performance and/or instability if the markup is sufficiently complex. However, since each of client computing devices 30 may be configured to assess the complexity of received markup before loading the markup, client computing devices 30 may prevent applications and/or portions of applications from loading if they exceed an acceptable threshold, and thus may minimize impact to a system's performance and stability.

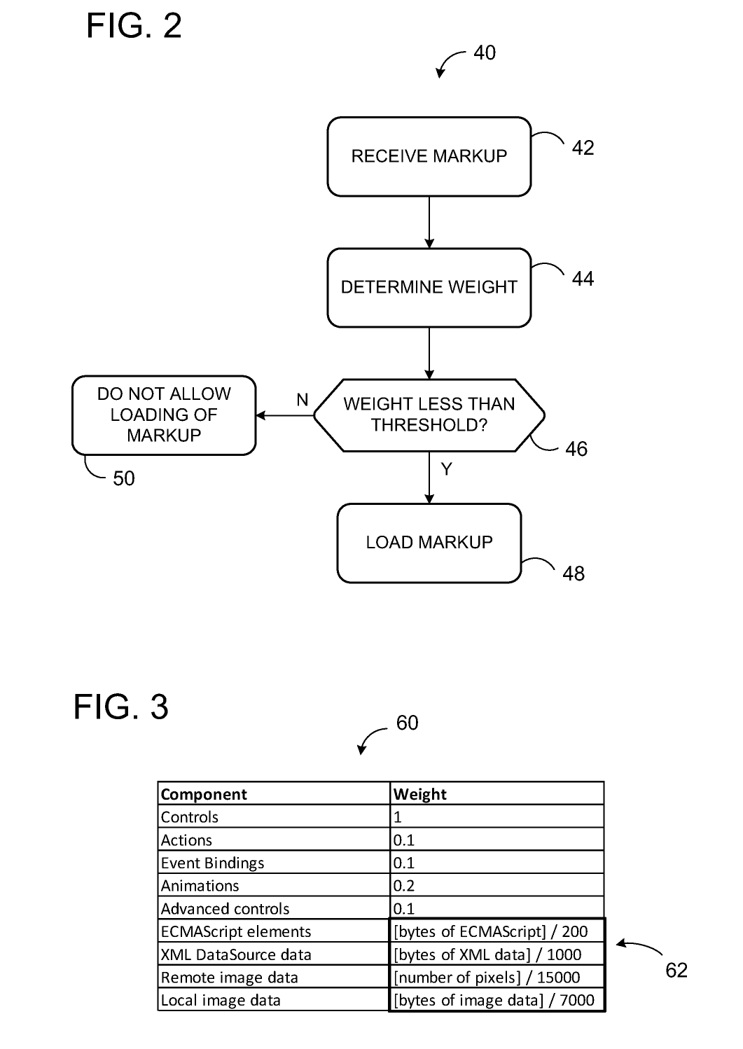

Each of client computing devices 30 may be configured to selectively load content using a method such as method 40 illustrated in FIG. 2 and described as follows. At 42, method 40 includes receiving markup at a client computing device. As described above, such markup may be received from any suitable source. Such a source may be, for example, an external source such as a network-accessible server. Markup may alternatively and/or additionally be received from a local source, such as a local mass storage device.

Markup may be received in response to a request from one of a variety of sources including the client computing device, a user of the client computing device, the server, etc. As an example, a user may select an option on a menu of the client computing device which may prompt the client computing device to request markup from a source. In some embodiments, such a source may be identified, for example, by a Uniform Resource Locator (URL). As another example, a user may launch an application on a client computing device which may be configured to monitor events and in response to detecting specific events launch an application requesting markup. Such events may include, but are not limited to, monitoring on-screen text, on-screen captions, channel changing, date/time, etc. As yet another example, a notification from the server may be used to deliver messages to a user and/or to launch applications at the client computing device, and thus the server may send markup to the client computing device.

It can be appreciated that such markup, or portions of such markup, may be “new” to the computing device in that it is independent from other markup rendered at the device, or may instead include portions of markup that are associated with markup previously or currently rendered on the device. For example the markup may include user interface elements for a new menu to be displayed by the client computing device. As another example, an application rendered on the device may request markup for additional buttons, images, etc. of an active application on the client computing system.

Upon receiving markup, and prior to rendering the markup, at 44, method 40 includes determining one or more weights for the markup, the weight indicating a complexity of the markup rather than memory usage. However, memory and other resources particular to the system may factor into the weight. Such weights provide a basis for the client computing device to allow or deny rendering of the markup. As will be described in more detail hereafter, by checking the markup before turning the markup into a live application, loading of a heavy application may be avoided altogether, as opposed to traditional approaches which may load an application and subsequently unload the application if it is determined to be too heavy. In some embodiments, a weight may be assigned to each portion of the markup (e.g., a portion of the parsed representation), and/or to live elements created directly without having originated in markup, as described in more detail below.

As an example, one or more portions of the parsed representation may be associated with various components, including but not limited to, controls, actions, events, animations, script data, etc., and a weight may be determined for each component. This allows for the client computing device to then allow or deny content on a component by component basis, based on the complexity of that component and how it may impact system performance and stability.

In some embodiments, each type of component may have a predetermined weight associated with it which is based on a complexity for that type of component. For example, each control may have a weight of 1 unit, whereas each animation may have a weight of 0.2 units, etc. As an example, FIG. 3 illustrates a table 60 of various example components and their associated weights, described in more detail hereafter.

Table 60 includes nonlimiting types of components listed in a left column, wherein each component corresponds to a predetermined example weight listed in the right column. The predetermined example weight indicates an estimated complexity of the parsed representation of the component, indicating how that component may impact system performance and stability. In the illustrated example, components having more complex parsed representation correspond to larger weights. It can be appreciated that the weights described herein are provided as examples, and that in practice different weights may be utilized. Furthermore the example components are nonlimiting, and any component of the markup may be assessed. Further, in some cases, components not directly described in the markup may be assessed.

As illustrated in table 60, the parsed representation may include various types of components. One type of component includes controls such as user interface objects such as buttons, text boxes, menus, etc. Controls may also include image controls which reference image files and are used to display images on the screen, and/or data source controls which reference an external source of markup data and cause the system to download that data.

Another type of component includes actions, wherein the system may use declarative actions as one of a variety of approaches for implementing logic on the client. In some embodiments, there may be a predefined set of action types, such that a developer may specify an action type and provide a name and associated parameters. As a nonlimiting example, a “tune action” may be used to change the channel on a client computing device displaying digital TV.

Yet another type of component includes event binding. Each of the plurality of controls may define various events and a developer may “bind” an action to the event so that the action executes when the event occurs. As an example, a button may be used to define an “on-click event.” A developer may bind the aforementioned tune action to a button on-click event, such that clicking the button causes the channel to change.

Another type of component includes animations, wherein an animation may cause the appearance of a user interface element to change over a period of time. An animation may be declared by specifying one or more animation types and the corresponding parameters. The animation may be applied to a control and may be triggered using certain animation cues and/or a specific type of action.

Components may also include advanced controls which dictate how displayed objects move. For example advanced controls may be used for a table or grid to dictate how scrolling, selection, etc. appears on the screen.

Components listed in table 60 further include ECMAScript elements, wherein the client computing device allows script code to be defined on the page or loaded remotely. As another example, a component may include XML DataSource data wherein XML data may be loaded by a datasource control. As yet another example, a component may include remote image data wherein image data may be loaded from the network (e.g., the Internet) to be displayed by an image control or to be used as the background, selected background, etc. of another control. As yet another example, a component may include local image data which is similar to remote image data described above except that local image data refers to images stored on the client itself.

It can be appreciated that the types of components described above are just a few examples of a variety of types of components, and additional types of components not described above are further included within the scope of this disclosure.

In some embodiments, at 44, method 40 may further include rounding the determined weight up to the nearest integer. As an example, the weights shown in the boxes outlined at 62 of FIG. 3 may be calculated with the given equation and then may be rounded up to the nearest integer.

Additionally or alternatively, a weight may be determined for each page based on the components of that page and their corresponding weights. Further, in some cases a total weight of various pages may be determined. Such a total may be, for example, a system total of all active pages on the client computing system.

At 46, method 40 includes determining if a weight of the parsed representation (e.g., a markup weight) is less than a threshold value. As used herein a threshold value includes any threshold value suitable for the parsed representation being examined. For example, if the parsed representation being examined corresponds to a page, then the markup weight may be compared to a page threshold value. However, if the parsed representation being examined corresponds to a component of a page, then the markup weight may be compared to a component threshold value. Further, if a page having several components is active on the system, then the markup weight corresponding to the component may not only be compared against a component threshold value, but a sum of the markup weight and the weight of all active page components may be compared to a page threshold value, to ensure that addition of the component will not cause the page to exceed its threshold. As yet another example, the system may have several active pages and/or a variety of active components, and the markup weight corresponding to the parsed representation being examined may be added to a total weight of the system to ensure that addition of the markup will not cause the system to exceed its threshold. Furthermore, a threshold value may be a hard threshold value such that exceeding the threshold is not permitted. However, in some cases, a threshold value may be a soft threshold value, in that exceeding the threshold is permitted yet may indicate a warning.

In embodiments where components are grouped into pages, a sum of the weights of the components associated with that page may be used to determine a page weight, and the page weight may then be compared to a threshold value. As such, each page of an application having a logical grouping of pages may be treated separately, thus allowing an application to be restricted on a page by page basis. Further, as described above, the system can have multiple pages loaded at once, wherein each page can be on a different layer. Since components may be grouped into different layers of pages, a weight of a main layer may be compared to a first threshold value, whereas a weight of a secondary layer may be compared to a second threshold value, for example. In some embodiments, the first threshold value corresponding to the main layer may be greater than the second threshold value corresponding to the secondary layer. In some embodiments, a lower bound for a weight of a page (e.g., a minimum page weight) may be determined based on selected components of that page and may exclude periphery components of that page. A lower bound may also be determined based on components of the parsed representation before they are turned into an actual page. As such, a client computing device may reject pages that violate a threshold before going through the effort of actually creating the live page. Further, in some embodiments, a client computing device may continually determine the weight of active pages on the device as well as determine each incoming markup weight, such that a total system weight may be compared to a total system threshold.

Threshold values may be stored at any suitable location accessible by the client computing device. As a nonlimiting example, thresholds may be included within a configuration file stored on the client computing device. Such a configuration file may be, for example, a local XML file that contains various settings and flags. As a possible use scenario, the client computing device may read this file as part of the boot process and store the threshold values. In some cases, one or more super-threshold values may be stored in this manner, while other sub-threshold values are calculated by subtracting a weight of currently loaded live elements from the super-threshold value. For example, if a layer is set to have a maximum weight of 500 units, and the currently loaded live elements has a weight of 300 units, the remaining available threshold may be calculated as 200 units (i.e., 500 units−300 units=200 units). This is explained in more detail below with reference to system thresholds, which are an example of a super-threshold.

If at 46 it is determined that a weight corresponding to the parsed representation is less than a threshold value (e.g., a super-threshold or sub-threshold), then at 48 method 40 includes loading the markup (e.g., loading the parsed representation). Thus, if the weight of an individual component is below its threshold value at 46, then that component may be rendered into its corresponding object/control/content, etc. If a page weight is below its threshold value at 46, then the parsed representation of the page may be rendered into its corresponding application or portion of an application. Further, if one or more layers are below one or more corresponding thresholds at 46, then those layers may be rendered. As another example, if a minimum weight is determined for a particular page and it is determined at 46 that the minimum weight of the page is less than a corresponding threshold, then the selected components associated with the minimum weight may be allowed to load, however additional periphery components of the page may not be loaded.

Alternatively, if at 46 it is determined that a weight corresponding to parsed representation is not less than its threshold value, then at 50 method 40 includes not allowing the parsed representation to load. In some embodiments, rendering of the single component may be aborted while other components of the page are allowed to load. However, in some embodiments, rendering of the page may be aborted. Further, in some embodiments an error message may indicate that content has not been loaded. As an example, the client computing device may display an error message or navigate a user to an error page. As another example, an error event may be passed to an associated application to indicate to the application that the requested parsed representation was not loaded. Further, if a weight was determined to be less than a threshold value and while constructing the live page objects it is determined that a particular threshold is exceeded, the loading of the rest of the page may be stopped.

As an example of a possible use scenario, one of the client computing devices 30 shown in FIG. 1, namely client computing device 32, may receive markup 26 and markup 27 from server 22 via network 24. In this use scenario, markup 26 and markup 27 can each represent a type of component, such as, for example, a control and an animation, respectively. In such a case, client computing device 32 may have an active application that called for the markup corresponding to the control and animation to be requested from server 22. Upon receiving markup 26 and markup 27, client computing device 32 may determine a weight for each markup, such as 200 units and 80 units respectively. Client computing device 32 may then determine if the weight of each markup is less than a threshold value. As an example, client computing device 32 may have a single threshold for components, such as 250 units. Thus, it may be determined that the weight of each markup is indeed below the threshold, and accordingly, markup 26 and markup 27 may each be rendered at client computing device 32 into the control and animation, respectively.

As another example of a possible use scenario, client computing device 34 may receive markup 28 and markup 29 from server 22 via network 24. In this use scenario, markup 28 and markup 29 may be associated with a page corresponding to an application. For example, markup 28 may represent a user interface and markup 29 may represent an image on that user interface. Upon receiving markup 28 and markup 29, client computing device 34 may determine a page weight by summing the weights associated with each markup. For example, if markup 28 has weight of 200 units and markup 29 has a weight of 80 units, then a page weight of 280 units may be determined. Client computing device 34 may then determine if the page weight is less than a threshold value. As an example, client computing device 34 may have a threshold for a page weight, such as 300 units. Thus, it is determined that page weight is below the threshold value, and accordingly, the page associated with markup 28 and markup 29 is rendered at client computing device 34.

As yet another example of a possible use scenario, client computing device 36 may receive markup 31 and markup 33 from server 22 via network 24. In this use scenario, markup 31 may correspond to a main layer of pages, and markup 33 may correspond to a secondary layer of pages. For example, markup 31 may correspond to components representing a user interface such as a menu guide, and markup 33 may correspond to components representing other content associated with the menu such as video viewers, advertisement panes, date/time stamp, etc. Upon receiving markup 31 and markup 33, client computing device 36 may determine a main layer weight by summing the weights of components associated with pages of the main layer. For example, markup 31 may have a weight of 200 units. Client computing device 36 may also determine a secondary layer weight by summing the weights of components associated with pages of the secondary layer. For example, markup 33 may have a weight of 80 units. Client computing device 36 may then determine if the main layer weight is below a first threshold value. As an example, client computing device 36 may have a first threshold value for a main layer weight, such as 300 units. Thus, it is determined that the main layer is below the first threshold value. Client computing device 36 may also determine if the secondary layer weight is below a second threshold value. As an example, client computing device 36 may have a second threshold value for a secondary layer weight, such as 75 units. Thus, it is determined that the secondary layer is not below the second threshold value. Accordingly, markup 31 may be allowed to render and markup 33 may be prevented from rendering.

In some embodiments, additional thresholds may exist. As an example, although a weight of markup (e.g., a weight of the parsed representation) may be below its tolerated threshold value, a weight corresponding to all active pages on the client may be such that rendering the markup may exceed total system capabilities. As such, a client computing device may further determine if the markup weight is less than a difference between a system threshold value and the actual weight of all pages actively loaded on the client. As an example, for the case of client computing device 36 described above, the client computing device may determine that the total weight associated with active pages on the device is currently 210 units. Including markup 31 having a weight of 200 units, the total system weight increases to 410 units. Client computing device 36 may then compare this total system weight to a system threshold. As an example, such a system threshold may be 425 units. Since the total system weight does not exceed the total threshold value, markup 31 may be allowed to render at client computing device 36.

It can be appreciated that method 40 may be performed continuously. For example, upon loading markup that is below its corresponding threshold, pages may load content (e.g., images, XML data, partial pages, etc.) dynamically after they have been constructed, however the computing device may continue to track the weight of this page and further assess any incoming markup. As an example, interacting with a page may cause additional markup to be received by the client computing device. Thus, a client computing device may continually track the weight of active pages on the system and evaluate each incoming markup weight to determine whether or not to allow the markup to load. In other words, if loading the new markup will cause the system to exceed its total threshold, then the markup may not be allowed to load. As another example, if loading new content will cause a page weight to cross a page threshold, the new content may not be attached to the page.

Further, in some embodiments, the client computing device may be configured to trigger a warning if a threshold has been reached. For example, the client computing device may have a soft threshold value that is smaller than a hard threshold value. When the soft threshold value is reached or exceeded, the parsed representation may still be allowed to load if the weight does not exceed the hard threshold value, but the device may indicate a warning to the user, application, etc. If the parsed representation exceeds the hard threshold value, that parsed representation may not be loaded.

Further, the client computing device may be configured to unload markup data and/or “purge” data from memory and thus decrease and/or remove weight associated with that data from the weight that is being tracked for that page. As nonlimiting examples, such a feature may be useful for images that are invisible, or for XML data sources that have loaded XML data, used it, and now are no longer needed. As such, purging may help maintain an acceptable system weight. Such purging may also allow developers to have more control over their applications, managing resource consumption on their pages and in the system overall. In some cases, purging may be dependent on the type of component on the page (e.g., images, data sources, subpages, etc.). In some cases, purging may be automatic, while in other cases purging may not be automatic. For example, a developer may program a page to automatically purge a component responsive to a preset triggering event (e.g., specific user input, elapsed duration, etc.).

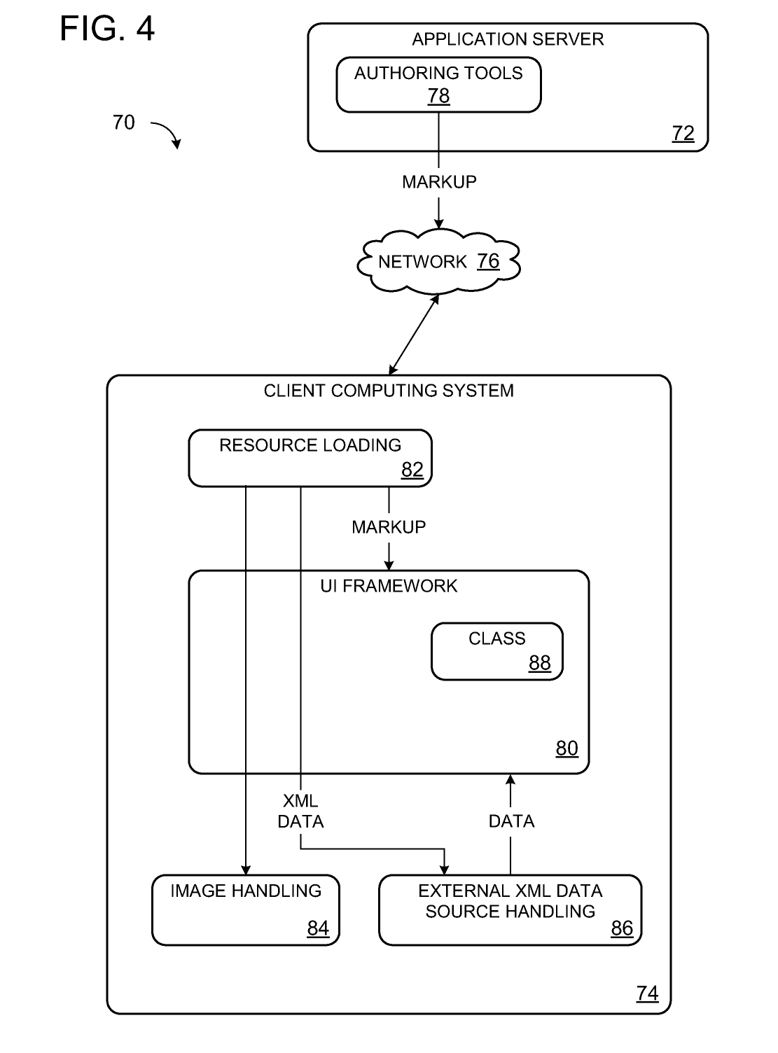

FIG. 4 illustrates an example computing environment architecture diagram. It can be appreciated that this is one possible architecture and that any suitable architecture may instead be used. Computing environment 70 may include an application server 72 configured to communicate with a client computing system 74 via a network 76. Application server 72 may include authoring tools 78 which may be used by a developer to author pages. Such authoring tools 78 may also be used by the developer to add purging actions, warning events, etc. to a page. When a remote page located at the application server is accessed, authoring tools 78 may generate the appropriate internal markup that will be consumed by client computing system 74. As an example, a page may be written using authoring tools 78.

Client computing system 74 may include a user interface (UI) framework module 80, wherein various pieces of code within the UI framework module 80 can trigger the loading of remote resources. As such, a resource loading module 82 of client computing system 74 may be configured to fetch remote resources over a network (e.g., via http, https, etc.) to be used by other modules of client computing system 74.

When a page is loaded, application server 72 may use controls 78 to generate internal markup for client computing system 74. Client computing system 74 may take that markup, parse it, and create “protogadgets” which are an internal, intermediate data structure. The tree of protogadgets may then become a real data structure, as opposed to text markup. The protogadgets may be more easily used for creating the final set of “gadgets.” In other words, client computing system 74 may be configured to process that tree, and from each protogadget produce a gadget. As such, a gadget may be used to describe a control. For example, a gadget may refer to an object on client computing system 74. A control may then refer either to the same object or to an object on the server that generates markup describing the client-side gadget. Examples of gadgets include, but are not limited to, buttons, text boxes, panels, and the like. A page may be described as a tree of gadgets, rooted in a gadget having a page type, for example, or a gadget type that may be inherited from a page.

Client computing system 74 may further include an image handling module 84 configured to decode image files into raw data used by the low level modules of client computing system 74. Image handling module 84 may be further configured to report the image size to UI framework module 80. If the image size, translated to a weight, is too much for the current page or for the system, UI framework module 80 may reject the image, and image handling module 84 may dispose of the data.

Client computing system 74 may further include an external XML data source handling module 86 configured to store XML data retrieved from remote sources and expose that data for use by UI framework module 80. The XML data source handling module 86 may be further configured to take text from the web response and create an XML data structure from that text. Accordingly, XML data source handling module 86 may be further configured to check with a class 88 to make sure the weight of the data fits under the limits. In some embodiments, class 88 may be part of UI framework module 80. Class 88 may be configured to manage the bookkeeping associated with assessing markup complexity. As such, class 88 may be configured to track the weight of pages and store the limit settings and other constants. When a piece of code is about to add weight to a page, UI framework module 80 may first check with class 88 to see if there is room for the new data or object. If there is room for the new data, UI framework module 80 may tell class 88 to track the weight for the new data or object. UI framework module 80 may further include the code to take markup that is local on the client computing system 74 or retrieved by the resource loading module 82 and produce a live page.

As such, client computing system 74 is configured to selectively load content based on complexity determined during “preflighting.” Preflighting allows client computing system 74 to reject pages that violate a threshold before client computing system 74 goes through the effort of actually creating the live page. When client computing system 74 has a tree of protogadgets, a lower bound may be calculated on the final page weight. This is described as a lower bound, rather than an exact weight, because the page may load image data, XML data, etc. to which client computing system 74 does not yet have access. The lower bound may be determined by looking at every protogadget in the tree and adding in the weight for the corresponding gadget type. Weight may also be added for actions, event bindings, animations, and inline scripts, which may not be gadgets but which may be described by the protogadget tree.

As described above, any component of the markup may be assessed, and in some cases, components not directly described in the markup may be assessed. Such components may be inferred or predicted from the markup. For example, a subpage gadget may be likely to contain at least one other gadget sometime after the page becomes active. As such, during preflighting, extra weight may be preemptively assigned to a subpage as a conservative prediction. Then, when the client computing system actually creates the subpage gadget, the client computing system can use the actual weight, rather than the conservative prediction.

In some embodiments, computing environment 70 may include a simulation of the client computing system which is configured to expose diagnostic information. Such a simulator tool may allow developers to see and analyze the weights of different components of a page (e.g., the gadget weights for a page, and look at the image weights, etc.), perform possible user interactions and assess the impact of such interactions on the computed complexity (“weight”). This kind of simulator tool allows developers to evaluate and tune their applications without directly hitting the physical limitations of the target client device.

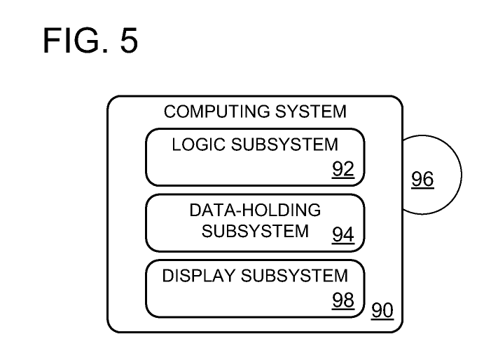

In some embodiments, the above described methods and processes may be tied to one or more computing systems. As an example, FIG. 5 schematically shows a computing system 90 that may perform one or more of the above described methods and processes. For example, computing system 90 may serve as server 22, client computing devices 30, application server 72, or client computing system 74. Computing system 90 includes a logic subsystem 92 and a data-holding subsystem 94. Computing system 90 may optionally include a display subsystem and/or other components not shown in FIG. 5.

Logic subsystem 92 may include one or more physical devices configured to execute one or more instructions. For example, the logic subsystem may be configured to execute one or more instructions that are part of one or more programs, routines, objects, components, data structures, or other logical constructs. Such instructions may be implemented to perform a task, implement a data type, transform the state of one or more devices, or otherwise arrive at a desired result. The logic subsystem may include one or more processors that are configured to execute software instructions. Additionally or alternatively, the logic subsystem may include one or more hardware or firmware logic machines configured to execute hardware or firmware instructions. The logic subsystem may optionally include individual components that are distributed throughout two or more devices, which may be remotely located in some embodiments.

Data-holding subsystem 94 may include one or more physical devices configured to hold data and/or instructions executable by the logic subsystem to implement the herein described methods and processes. When such methods and processes are implemented, the state of data-holding subsystem 94 may be transformed (e.g., to hold different data). Data-holding subsystem 94 may include removable media and/or built-in devices. Data-holding subsystem 94 may include optical memory devices, semiconductor memory devices, and/or magnetic memory devices, among others. Data-holding subsystem 94 may include devices with one or more of the following characteristics: volatile, nonvolatile, dynamic, static, read/write, read-only, random access, sequential access, location addressable, file addressable, and content addressable. In some embodiments, logic subsystem 92 and data-holding subsystem 94 may be integrated into one or more common devices, such as an application specific integrated circuit or a system on a chip.

FIG. 5 also shows an aspect of the data-holding subsystem in the form of computer-readable removable media 96, which may be used to store and/or transfer data and/or instructions executable to implement the herein described methods and processes.

The terms “module” and “engine” may be used to describe an aspect of computing system 90 that is implemented to perform one or more particular functions. In some cases, such a module or engine may be instantiated via logic subsystem 92 executing instructions held by data-holding subsystem 94. It is to be understood that different modules and/or engines may be instantiated from the same application, code block, object, routine, and/or function. Likewise, the same module and/or engine may be instantiated by different applications, code blocks, objects, routines, and/or functions in some cases.

When included, display subsystem 98 may be used to present a visual representation of data held by data-holding subsystem 94. As the herein described methods and processes change the data held by the data-holding subsystem, and thus transform the state of the data-holding subsystem, the state of display subsystem 98 may likewise be transformed to visually represent changes in the underlying data. Display subsystem 98 may include one or more display devices utilizing virtually any type of technology. Such display devices may be combined with logic subsystem 92 and/or data-holding subsystem 94 in a shared enclosure, or such display devices may be peripheral display devices.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above⁻described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method of selectively loading content, comprising:
receiving markup data at a client computing device;
determining a markup weight for the markup data at the client computing device;
determining if the markup weight is less than a threshold value at the client computing device;
if the markup weight is less than the threshold value, loading the markup data at the client computing device; and
if the markup weight is not less than the threshold value, not allowing the markup data to load at the client computing device.

2. The method of claim 1, where the markup data is uncompiled text-based markup data.

3. The method of claim 1, where the markup data is extensible markup language data.

4. The method of claim 1, where the markup data is a constituent portion of a markup package including other markup data, the constituent portion of the markup package being associated with a markup component.

5. The method of claim 4, where determining the markup weight for the markup data includes reading the markup weight associated with the markup component in a lookup data structure.

6. The method of claim 4, where the markup component is a control, action, event binding, animation, ECMAScript element, XML DataSource, or remote image data.

7. The method of claim 1, where determining if the markup weight is less than the threshold value includes determining if the markup weight is less than a hard threshold value and a soft threshold value, wherein if the markup weight is less than the hard threshold value and greater than the soft threshold value, the markup data is loaded and a warning is indicated.

8. The method of claim 1, where determining if the markup weight is less than the threshold value includes determining if the markup weight is less than a difference between a system threshold value and a weight of markup objects actively loaded at the client computing device.

9. The method of claim 1, further comprising, in response to loading the markup data at the client computing device, increasing a weight of markup objects actively loaded at the client computing device by the markup weight of the markup data.

10. The method of claim 1, further comprising, in response to unloading the markup data at the client computing device, decreasing the weight of markup objects actively loaded at the client computing device by the markup weight of the markup data.

11. The method of claim 1, where receiving markup data at the client computing device includes receiving markup data from a network-accessible server.

12. The method of claim 1, where receiving markup data at the client computing device includes receiving markup data from a local mass storage device.

13. The method of claim 1, further comprising requesting markup data from a source identified by a Uniform Resource Locator.

14. A method of selectively loading content, comprising:
receiving markup data at a client computing system from an application server via a network;
parsing the markup data into an internal intermediate data structure;
determining at the client computing system a markup weight for the markup data based on a complexity of the markup data;
determining at the client computing system if the markup weight is less than a threshold value;
if the markup weight is less than the threshold value, loading the markup data into an active markup object at the client computing system; and
if the markup weight is not less than the threshold value, not allowing the markup data to load into the active markup object at the client computing system.

15. The method of claim 14, further comprising, upon parsing the markup data into the internal intermediate data structure, creating from the internal intermediate data structure a tree having a real data structure.

16. The method of claim 14, wherein parsing the markup data into the internal intermediate data structure includes creating a protogadget from the markup data and wherein loading the markup data into the active markup object includes producing a gadget from the protogadget.

17. The method of claim 14, further comprising tracking via a class of the client computing system a total system weight of markup objects actively loaded on the client computing system and determining if a sum of the markup weight and the total system weight is less than a system threshold value.

18. The method of claim 17, further comprising if the markup weight is less than the threshold value and the sum is less than the system threshold value, loading the markup data into an active markup object at the client computing system.

19. The method of claim 14, wherein receiving the markup data is in response to requesting at the client computing system to load a page from the application server, and wherein the markup data is internal markup data of the page generated by the application server for the client computing system.

20. A data-holding subsystem holding instructions executable by a logic subsystem to:
determine a markup weight for markup data at a client computing device;
determine if the markup weight is less than a threshold value at the client computing device;
if the markup weight is less than the threshold value, load the markup data at the client computing device; and
if the markup weight is not less than the threshold value, not allow the markup data to load at the client computing device.
